(19) United States
(12) Patent Application Publication
(10) Pub. No.: US 2010/0300803 A1
(43) Pub. Date: Dec. 2, 2010

(54) HARNESS FOR PERSONAL SAFETY

(75) Inventor: Kai Rinklake, Neuwied (DE)

Correspondence Address: LAW OFFICE OF DELIO & PETERSON, LLC., 121 WHITNEY AVENUE, NEW HAVEN, CT, 06510, US

(73) Assignee: SKYLOTEC GMBH, Neuwied, DE (DE)

(21) Appl. No.: 12/677,878

(22) PCT Filed: Aug. 27, 2008
(86) PCT No.: PCT/EP08/07025

§ 371 Date: Mar. 12, 2010

(30) Foreign Application Priority Data
Sep. 14, 2007 (DE) 20 2007 012 878.9

(51) Int. Cl. A62B 35/00; A63B 29/00

(52) U.S. Cl. 182/3

(57) ABSTRACT

The invention relates to a harness for personal safety, particularly a safety harness, climbing harness, or seat harness, particularly for a carabiner, wherein the belay device is disposed on a belt of the harness and the belt is enclosed by a first enclosing band that forms the load-bearing portion of the belt. The arrangement is made such that the belay device is formed by at least one enclosing band, which is connected to the belt by a predetermined section so as to enclose the belt, and which is released from the belt via another predetermined section.

This application is a National Phase filing of PCT/EP2008/007025 filed Aug. 27, 2008, under 35 U.S.C. §371, and claims priority to German Application No. DE 20 2007 012 878.9 filed Sep. 14, 2007.

### BACKGROUND OF THE INVENTION

1. Field of the Invention

The present invention relates to a harness for personal safety, particularly a safety harness, climbing harness, or seat harness, comprising at least one attachment eyelet for a securing means, particularly for a carabiner, wherein the attachment eyelet is disposed on a belt of the harness and the belt is edged by a first edging band that forms the load-bearing portion of said belt, according to the preamble of claim 1.

2. Description of Related Art

EP 1 326 682 B1 discloses a protective harness with a sacral portion and two leg portions, wherein the sacral portion consists of padding and edging bands which edge the padding and simultaneously form the supporting elements of the belt.

### SUMMARY OF THE INVENTION

Bearing in mind the problems and deficiencies of the prior art, it is therefore an object of the present invention to improve a harness of the aforementioned type with regard to the attachment eyelets.

This aim is achieved according to the invention with a harness of the aforementioned type having the features characterized in claim 1. Advantageous embodiments of the invention are described in the other claims.

Still other objects and advantages of the invention will in part be obvious and will in part be apparent from the specification.

The above and other objects, which will be apparent to those skilled in the art, are achieved in the present invention which is directed to a harness for personal safety comprising at least one attachment eyelet for securing a carabiner, the attachment eyelet disposed on a belt of the harness, the belt edged by a first edging band that forms a load-bearing portion of the belt, including having the attachment eyelet made from at least one edging band which is connected to the belt in edging manner at a predetermined section and is detached from the belt at another predetermined section.

The at least one edging band forming the attachment eyelet may be configured as a ring-shaped eyelet. The ring-shaped edging band may comprise a first ring section which is connected to the belt in edging manner and a second ring section which is detached from the belt, where the second ring section may be longer than the first ring section.

The attachment eyelet may be configured from a section of the first edging band such that the first edging band is detached from the belt at a first site of the belt and, at a second site of the belt is attached thereto again, wherein the section of the first edging band forming the attachment eyelet extends from the first site of the belt to the second site of the belt.

The section of the first edging band forming the attachment eyelet is preferably longer than a distance from the first site to the second site of the belt along the belt over which the first edging band is detached from the belt.

A second ring-shaped edging band having a first ring section may be attached to the belt approximately between the first site and the second site of the belt and connected thereto in edging manner. A second ring section, which is connected to the section of the first edging band, forms the attachment eyelet.

A third edging band may be connected to the belt in edging manner such that over the whole region of the belt between the first site and the second site where the first edging band is detached from the belt, and over a respective predetermined region, the third edging band extends beyond the first site and the second site.

The belt, upon which the attachment eye is disposed, may comprise a chest belt or a shoulder belt and the attachment eyelet may comprise a chest belt eyelet.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 shows a preferred embodiment of a harness according to the invention in a perspective view.

FIG. 2 shows a schematic representation of a first preferred embodiment of an attachment eyelet configured according to the invention.

FIG. 3 shows a schematic representation of a second preferred embodiment of an attachment eyelet configured according to the invention.

### DESCRIPTION OF THE PREFERRED EMBODIMENT(S)

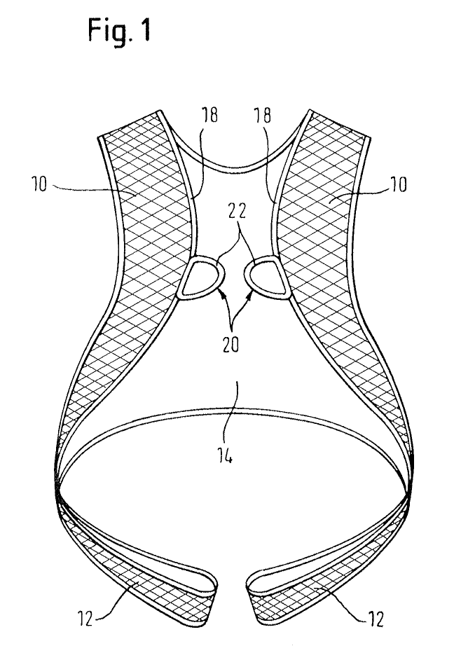

In describing the preferred embodiment of the present invention, reference will be made herein to FIGS. 1-3 of the drawings in which like numerals refer to like features of the invention.

It is provided according to the invention in a harness of the aforementioned type that the attachment eyelet is made from at least one edging band which is connected to the belt in edging manner at a predetermined section and is detached from the belt at another predetermined section.

This has the advantage that the harness can be produced easily and cost-effectively, since the attachment eyelet does not need any belt band fabric and can easily be configured together with the edging of the belt band.

In a first preferred embodiment, the edging band forming the attachment eyelet is configured ring-shaped, wherein the ring-shaped edging band comprises a first ring section which is connected to the belt in edging manner and comprises a second ring section which is detached from the belt. Preferably, the second ring section is longer than the first ring section.

In an alternative preferred embodiment, the attachment eyelet is configured from a section of the first edging band such that the first edging band is detached from the belt at a first site of the belt and, at a second site of the belt is attached thereto again, wherein the section of the first edging band forming the attachment eyelet extends from the first site of the belt to the second site of the belt. As a result, the attachment eyelet can be more easily configured together with the edging of the belt band.

An attachment eyelet with a large diameter that is particularly easy to use is achieved in that the section of the first edging band forming the attachment eyelet is longer than a distance from the first site to the second site of the belt along the belt over which the first edging band is detached from the belt.

Mechanical reinforcement of the attachment eyelet is achieved in that a second ring-shaped edging band is provided which has a first ring section which is attached to the belt between the first site and the second site of the belt and is connected thereto in edging manner, and has a second ring section which is connected to the section of the first edging band forming the attachment eyelet.

A particularly high strength in the region of the attachment eyelet and good conduction of forces into the region of the belt that is edged with the first edging band is achieved in that a third edging band is provided which is connected to the belt in edging manner such that over the whole region of the belt between the first site and the second site in which the first edging band is detached from the belt and over a respective predetermined region, in each case, the third edging band extends beyond the first site and the second site.

Suitably, in the region in which the third edging band extends beyond the first site and the second site, said third edging band is disposed between the belt and the first edging band.

Suitably, the belt on which the attachment eye is disposed is a chest belt or a shoulder belt and the attachment eyelet is a chest belt eyelet.

The preferred embodiment of a harness according to the invention shown in FIG. 1 comprises two shoulder portions 10 and two leg portions 12. The shoulder portions 10 are connected to one another at the end to form a sacral portion 14 and at the respective other end, respectively, to a leg portion 12. The leg portions 12 are also connected to the sacral portion 14. In the embodiment shown, shoulder portions 10, leg portions 12 and the sacral portion 14 are configured integrally from one edged piece of fabric.

The shoulder portions 10, the leg portions 12 and the sacral portion 14 are each made from a mesh fabric and are edged with a first edging band 18. The first edging bands 18 of the shoulder portions 10, the leg portions 12 and the sacral portion 14 are connected to one another and configured such that the first edging bands 18 form the load-bearing elements of the harness.

The shoulder portions 10 and the sacral portion 14 together are cut in the form of a waistcoat. Attachment eyelets 20 are also provided on the shoulder portions 10. The arrangement of the attachment eyelets 20 in the purely exemplary embodiment shown is such that said eyelets are chest belt eyelets. The attachment eyelet 20 can also be disposed on any other belt of the harness. The waistcoat consisting of shoulder portions 10 and sacral portion 14 is itself made from an air-permeable fabric. Each attachment eyelet 20 is made from at least one second edging band 22 which is attached over a predetermined section to the belt of the shoulder portion 10 and bound thereto in edging manner and, over another predetermined section, is detached from the belt of the shoulder portion 10. In other words, the second edging band 22 is detached, over a predetermined section, from a connection to the belt of the shoulder portion 10, said connection edging the belt of the shoulder portion 10. This predetermined section forms an attachment eyelet 20, in the shape of a loop for a securing means, for example, a carabiner or a sling. The second edging band 22 can be identical to the first edging band 18 or at least one additional edging band.

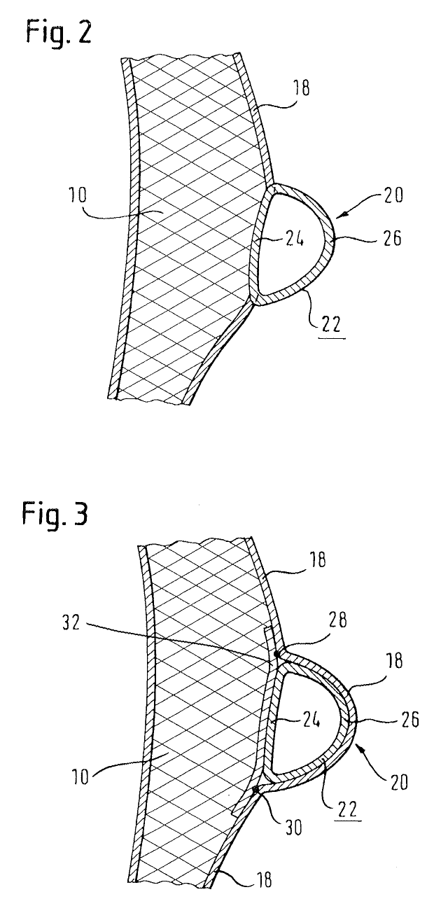

FIG. 2 shows a first preferred embodiment of an attachment eyelet 20 configured as a chest belt eyelet on the shoulder belt 10. This is purely exemplary, and the attachment eyelet 20 can also be disposed on any other belt of the harness. The first edging band 18 extends unchanged along the belt of the shoulder portion 10 and the attachment eyelet 20 is made from the additional second edging band 22. This second edging band 22 is configured as a closed ring with a first ring section 24 which is connected to the belt of the shoulder portion 10 in edging manner, and with a second ring section 26, is detached from the belt of the shoulder portion 10 or from a connection edging the belt.

FIG. 3 shows a second preferred embodiment of an attachment eyelet 20 which is configured as a chest belt eyelet on the belt of the shoulder portion 10. This is purely exemplary, however, and the attachment eyelet 20 can also be disposed on any other belt of the harness. In this embodiment, the attachment eyelet 20 comprises a plurality of different, but mutually attached, edging bands. A section of the first edging band 18 forms a loop such that the first edging band 18 is detached from said belt at a first site 28 of the belt of the shoulder portion 10 and at a second site 30 of the belt is connected thereto again, wherein the section of the first edging band 18 forming the attachment eyelet 20 extends from the first site 28 of the belt of the shoulder portion 10 to the second site 30 of the belt of the shoulder portion 10. This section of the first edging band 18 forming the attachment eyelet 20 is detached from a connection edging the belt, i.e. it is not connected to the belt.

A second ring-shaped edging band 22 is additionally provided which comprises a first ring section 24 which is connected to the belt of the shoulder portion 10 between the first site 28 and the second site 30 of the belt of the shoulder portion 10 in edging manner, and comprises a second ring section 26 which is connected to the section of the first edging band 18 forming the attachment eyelet 20.

Finally, a third edging band 32 is provided which is connected to the belt of the shoulder portion 10 in edging manner such that the third edging band 32 extends over the whole region of the belt between the first site 28 and the second site 30 in which the first edging band 18 is detached from the belt of the shoulder portion 10, and over, respectively, a predetermined region beyond the first site 28, and a predetermined region beyond the second site 30 along the belt, and is attached to said belt in edging manner.

In effect, therefore, the result is an optimized conduction of forces from the attachment eyelet 20 to the first edging band 18 at the belt of the shoulder portion 10 regardless of the direction in which the force acts on the attachment eyelet 20.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A harness for personal safety comprising at least one attachment eyelet for securing a carabiner, said attachment eyelet disposed on a belt of the harness, said belt edged by a first edging band that forms a load-bearing portion of said belt, including having the attachment eyelet made from at least one edging band which is connected to the belt in edging manner at a predetermined section and is detached from the belt at another predetermined section.

2. The harness of claim 1 including having said at least one edging band forming the attachment eyelet configured as a ring-shaped eyelet.

3. The harness of claim 2 including having said at least one ring-shaped edging band comprise a first ring section which is connected to the belt in edging manner and a second ring section which is detached from the belt.

4. The harness of claim 3 including having said second ring section longer than the first ring section.

5. The harness of claim 1 including having the attachment eyelet configured from a section of the first edging band such that the first edging band is detached from the belt at a first site of the belt and, at a second site of the belt is attached thereto again, wherein the section of the first edging band forming the attachment eyelet extends from the first site of the belt to the second site of the belt.

6. The harness of claim 5 including having the section of the first edging band forming the attachment eyelet longer than a distance from the first site to the second site of the belt along the belt over which the first edging band is detached from the belt.

7. The harness of claim 5 including a second ring-shaped edging band having a first ring section which is attached to the belt approximately between the first site and the second site of the belt and is connected thereto in edging manner, and a second ring section which is connected to the section of the first edging band forming the attachment eyelet.

8. The harness of claim 5 including a third edging band connected to the belt in edging manner such that over the whole region of the belt between the first site and the second site where the first edging band is detached from the belt, and over a respective predetermined region, the third edging band extends beyond the first site and the second site.

9. The harness of claim 8 including, in the region in which the third edging band extends beyond the first site and the second site, said third band is disposed between the belt and the first edging band.

10. The harness of claim 1 including having the belt on which the attachment eye is disposed comprising a chest belt or a shoulder belt and the attachment eyelet comprising a chest belt eyelet.

11. The harness of claim 6 including a second ring-shaped edging band having a first ring section which is attached to the belt approximately between the first site and the second site of the belt and is connected thereto in edging manner, and a second ring section which is connected to the section of the first edging band forming the attachment eyelet.

12. The harness of claim 7 including a third edging band connected to the belt in edging manner such that over the whole region of the belt between the first site and the second site where the first edging band is detached from the belt, and over a respective predetermined region, the third edging band extends beyond the first site and the second site.

13. The harness of claim 1 including having the belt on which the attachment eye is disposed comprising a chest belt or a shoulder belt and the attachment eyelet comprising a chest belt eyelet.

14. The harness of claim 4 including having the belt on which the attachment eye is disposed comprising a chest belt or a shoulder belt and the attachment eyelet comprising a chest belt eyelet.

15. The harness of claim 5 including having the belt on which the attachment eye is disposed comprising a chest belt or a shoulder belt and the attachment eyelet comprising a chest belt eyelet.

16. The harness of claim 7 including having the belt on which the attachment eye is disposed comprising a chest belt or a shoulder belt and the attachment eyelet comprising a chest belt eyelet.

17. The harness of claim 8 including having the belt on which the attachment eye is disposed comprising a chest belt or a shoulder belt and the attachment eyelet comprising a chest belt eyelet.
